(19) United States
(12) Patent Application Publication
(10) Pub. No.: US 2015/0036568 A1
(43) Pub. Date: Feb. 5, 2015

(54) WIRELESS COMMUNICATIONS TERMINAL AND CONTROL METHOD THEREOF

(71) Applicant: SAMSUNG ELECTRO-MECHANICS CO., LTD., Suwon (KR)

(72) Inventor: Ki Han HWANG, Suwon (KR)

(73) Assignee: SAMSUNG ELECTRO-MECHANICS CO., LTD., Suwon (KR)

(21) Appl. No.: 14/066,210

(22) Filed: Oct. 29, 2013

(30) Foreign Application Priority Data
Aug. 2, 2013 (KR) 10-2013-0092170

(51) Int. Cl. H04W 52/02

(52) U.S. Cl. CPC H04W 52/0241
USPC 370/311

(57) ABSTRACT

There is provided a wireless communications terminal including a Wi-Fi module connected to the Internet wirelessly via an access point (AP), a mobile communications module calculating position information regarding the wireless communications terminal, a memory unit storing Wi-Fi connection information previously set, and a control unit turning off the Wi-Fi module in a case in which the position information is outside of an effective range of the Wi-Fi connection information when the Wi-Fi module is in an ON state.

### CROSS-REFERENCE TO RELATED APPLICATIONS

This application claims the benefit of Korean Patent Application No. 10-2013-0092170 filed on Aug. 2, 2013, with the Korean Intellectual Property Office, the disclosure of which is incorporated herein by reference.

### BACKGROUND OF THE INVENTION

1. Field of the Invention

The present invention relates to a wireless communications terminal and a control method thereof.

2. Description of the Related Art

In the case of a wireless communications terminal such as a smartphone having high performance, the amount of battery power consumed due to the high performance thereof may be increased, such that the saving and management of battery power has emerged as an important issue.

Therefore, when wireless communications terminal manufacturing companies develop new products, they place emphasis on technologies for saving the amount of battery power consumed, using an increase in battery capacity, the application of low power-consuming parts, and methods of controlling power use of each individual module within a wireless communications terminal.

Wireless communications terminals having a Wi-Fi function and a mobile communication function such as smartphones include a module performing a wireless communication function in addition to a module performing a basic communications function.

Among these, the Wi-Fi function is the technology currently most often used in wireless communications terminals because it is frequently free and has an advantage of high speed. In this case, the wireless communications terminal needs to be connected to an access point (AP) in the vicinity of the wireless communications terminal in order to use the Wi-Fi function.

To this end, it is premised that the Wi-Fi function of the wireless communications terminal is activated, but such a function is often activated, even in cases in which a user does not require the Wi-Fi function. In this case, the wireless communications terminal performs a task of periodically searching for the access point to be connected to the access point, such that this task causes an increase in battery power of the wireless communications terminal to be unnecessarily consumed.

Patent Document 1, the following Related Art Document, relates to a mobile terminal and a control method of a mobile terminal, and does not disclose contents of calculating position information regarding the mobile terminal and turning off a Wi-Fi module in the case in which the position information indicates that the mobile terminal is not in an effective range of Wi-Fi connection information.

### RELATED ART DOCUMENT

(Patent Document 1) Korean Patent Laid-Open Publication No. 10-2012-0124111

### SUMMARY OF THE INVENTION

An aspect of the present invention provides a wireless communications terminal capable of decreasing an unnecessarily consumed amount of battery power thereof by calculating position information regarding the wireless communications terminal and determining whether the position information is within an effective range of Wi-Fi connection information previously stored to thereby inactivate an unnecessary Wi-Fi function, and a control method thereof.

According to an aspect of the present invention, there is provided a wireless communications terminal, including: a Wi-Fi module connected to the Internet wirelessly via an access point (AP); a mobile communications module calculating position information regarding the wireless communications terminal; a memory unit storing Wi-Fi connection information previously set; and a control unit turning off the Wi-Fi module in a case in which the position information is outside of an effective range of the Wi-Fi connection information when the Wi-Fi module is in an ON state.

The position information may be calculated using a received signal strength indication (RSSI) from a base station or using a global position system (GPS).

The Wi-Fi connection information may include: information regarding a plurality of access points to which the wireless communications terminal has been previously connected; and terminal coordinates for each of the plurality of access points to which the wireless communications terminal has been previously connected.

The control unit may calculate a distance between the respective terminal coordinates and coordinates of a current position of the wireless communications terminal included in the position information, and may determine whether the plurality of access points are within the effective range.

The control unit may connect the wireless communications terminal to one of the plurality of access points determined as being within the effective range.

The wireless communications terminal may further include a display unit outputting the ON or an OFF state of the Wi-Fi module.

The control unit may maintain the ON state of the Wi-Fi module when the Wi-Fi module transmits and receives data to and from the access point, while being in the ON state.

The control unit may periodically determine whether the Wi-Fi module and the access point transmit and receive data to and from each other.

According to an aspect of the present invention, there is provided a control method of a wireless communications terminal, the control method including: determining whether a Wi-Fi module is in an ON state; calculating position information regarding the wireless communications terminal and determining whether the position information is within an effective range of Wi-Fi connection information previously set, when the Wi-Fi module is in the ON state; and turning off the Wi-Fi module when the position information is outside of the effective range of the Wi-Fi connection information.

The control method may further include determining whether the Wi-Fi module transmits and receives data to and from the access point.

The control method may further include maintaining the ON state of the Wi-Fi module when the Wi-Fi module transmits and receives data to and from the access point.

The control method may further include periodically determining whether the Wi-Fi module and the access point transmit and receive data to and from each other when the Wi-Fi module is in the ON state.

The determining of whether the position information is within the effective range of the Wi-Fi connection information may include: calculating the position information using a received signal strength indication (RSSI) from a base station or calculating the position information using a global positioning system (GPS).

The determining of whether the position information is within the effective range of the Wi-Fi connection information may include: storing terminal coordinates for each of the plurality of access points in the memory unit; calculating a distance between the respective terminal coordinates and coordinates of a current position of the wireless communications terminal included in the position information; and determining whether the position information is within the effective range of the Wi-Fi connection information, depending on the calculated distance.

The control method may further include connecting the wireless communications terminal to one of plurality of access points determined as being within the effective range.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a wireless communications terminal according to an embodiment of the present invention;

FIG. 2 is an exemplary configuration diagram illustrating the wireless communications terminal and a control method thereof according to an embodiment of the present invention;

FIG. 3 is an exemplary table illustrating Wi-Fi connection information according to the embodiment of the present invention;

FIG. 4A is an exemplary configuration diagram illustrating a case in which the wireless communications terminal according to the embodiment of the present invention is moved;

FIG. 4B is another exemplary configuration diagram illustrating a case in which the wireless communications terminal according to the embodiment of the present invention is moved;

FIG. 5 is a flowchart illustrating an example of the control method of the wireless communications terminal according to the embodiment of the present invention;

FIG. 6 is a flowchart illustrating another example of the control method of the wireless communications terminal according to the embodiment of the present invention;

FIG. 7 is a flow chart illustrating a method of calculating position information according to the embodiment of the present invention; and

FIG. 8 is a flow chart illustrating a method of determining whether the position information is within an effective range of Wi-Fi connection information according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

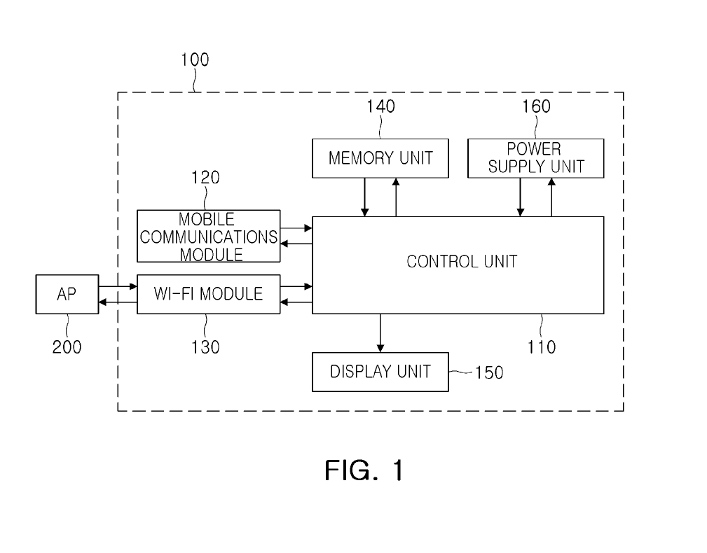

FIG. 1 is a block diagram illustrating a wireless communications terminal 100 according to an embodiment of the present invention.

Referring to FIG. 1, the wireless communications terminal 100 according to the embodiment of the present invention may include a control unit 110, a mobile communications module 120, a Wi-Fi module 130, a memory unit 140, a display unit 150, and a power supply unit 160.

The Wi-Fi module 130 may be connected to the Internet wirelessly and may transmit and receive data via an access point 200.

The memory unit 140 may store Wi-Fi connection information previously set.

The control unit 110 may determine whether position information regarding the wireless communications terminal 100 is within an effective range of the Wi-Fi connection information when the Wi-Fi module 130 is in an ON state, and may turn off the Wi-Fi module in the case in which the position information is outside of the effective range as the result of the determination.

The display unit 150 may output information as to whether the Wi-Fi module 130 is in the ON state or an OFF state on a screen.

The power supply unit 160 may supply power to the wireless communications terminal 100 according to a control of the control unit 110 and may include a battery, by way of example.

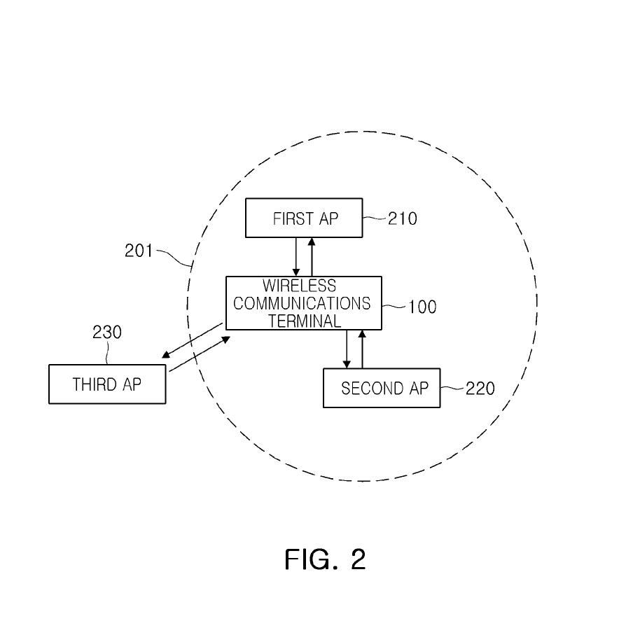

FIG. 2 is an exemplary configuration diagram illustrating the wireless communications terminal 100 and a control method thereof according to an embodiment of the present invention.

The wireless communications terminal 100 according to the embodiment of the present invention will be described in detail with reference to FIGS. 1 and 2.

The control unit 110 may determine whether the Wi-Fi module 130 of the wireless communications terminal 100 is currently in the ON state or the OFF state. In a case in which the Wi-Fi module 130 is in the ON state, the case may represent a state in which a Wi-Fi function is activated.

That is, the Wi-Fi module 130 may continuously search for the access point 200 in the vicinity thereof and may transmit and receive data in the case of a connection thereof to the access point 200. Meanwhile, in a case in which the Wi-Fi module 130 is in the OFF state, the case may represent a state in which the Wi-Fi function is inactivated. In this case, the Wi-Fi module 130 may not transmit data to the access point 200.

Thereafter, when the Wi-Fi module 130 is in the ON state, it may be determined as to whether the wireless communications terminal 100 transmits and receives data to and from the access point 200 via the Wi-Fi module 130. In this case, when the wireless communications terminal 100 transmits and receives data to and from the access point 200 via the Wi-Fi module 130, since a user currently uses the Wi-Fi function, it may not required to control the Wi-Fi module 130. Therefore, the control unit 110 may maintain the ON state of the Wi-Fi module 130.

Meanwhile, the wireless communications terminal 100 may not transmit and receive data to and from the access point 200. In preparation for this case, the control unit 110 may periodically determine whether the Wi-Fi module 130 and the access point 200 transmit and receive data to and from each other.

However, when the wireless communications terminal 100 does not transmit and receive data to and from the access point 200, it means that the Wi-Fi module 130 unnecessarily searches for the access point 200 in the vicinity thereof. Therefore, the control unit 110 needs to control the Wi-Fi module 130.

That is, when the Wi-Fi module 130 is currently in the ON state and does not transmit and receive data to and from the access point 200 for a predetermined time, the wireless communications terminal 100 may calculate the position information regarding the wireless communications terminal 100 to thereby determine whether the position information is within an effective range of Wi-Fi connection information previously set.

In this case, the position information may include coordinates of a current position of the wireless communications terminal 100. In this case, the position information may be calculated using a received signal strength indication (RSSI) from a base station or using a global positioning system (GPS) embedded in the wireless communications terminal 100.

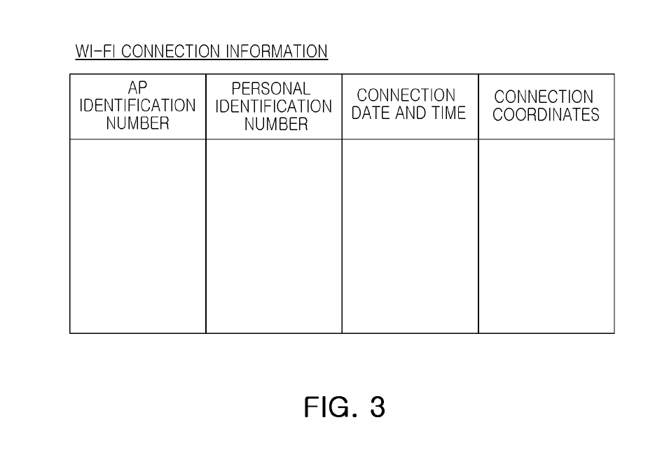

Meanwhile, the Wi-Fi connection information may be information regarding a plurality of access points to which the wireless communications terminal 100 has previously been connected. More specifically, a detailed description thereof will be provided with reference to FIG. 3.

FIG. 3 is an exemplary table illustrating Wi-Fi connection information according to the embodiment of the present invention.

That is, the wireless communications terminal 100 according to the embodiment of the present invention may store the information regarding the plurality of access points to which the wireless communications terminal 100 has previously been connected, in the memory unit 140, and the information regarding the access points may include an identification number, a personal identification number, and date and time of connection of the access point. In addition, the wireless communications terminal 100 may calculate the position information at the time of the connection thereof to each of the plurality of access points, as terminal coordinates and may store the terminal coordinates.

A method of determining whether the calculated position information is within the effective range of the Wi-Fi connection information previously set will be described with reference to FIG. 2. The wireless communications terminal 100 may store identification numbers, personal identification numbers, and dates and times for the plurality of access points to which the wireless communications terminal 100 has previously been connected, for example, a first AP 210, a second AP P 220, and a third AP 230, in the memory unit 140. Further, the position information regarding the wireless communications terminal 100 when the wireless communications terminal 100 is connected to the first AP 210, the second AP 220, and the third AP 230 may be calculated as the terminal coordinates to thereby be stored in the memory unit 140.

Thereafter, when wireless communications terminal 100 is currently positioned at the position shown in FIG. 2, the Wi-Fi module 130 is in the ON state, and the wireless communications terminal 100 does not transmit and receive data, the wireless communications terminal 100 may calculate the position information regarding the current position thereof using the received signal strength indication (RSSI) received from the base station or using the global positioning system (GPS) embedded in the wireless communications terminal 100.

More specifically, an algorithm for storing position information will be described. The wireless communications terminal 100 according to the embodiment of the present invention may first search for whether or not the access point, for example, the first AP 210, the second AP 220, the third SP 230, or the like, which may be connected to the wireless communications terminal 100 by the Wi-Fi function of the wireless communications terminal 100 currently activated, exists in the vicinity of the wireless communications terminal 100, and may determine whether the wireless communications terminal 100 may be connected to the searched plurality of access points. If the plurality of access points may not searched or the connections thereof may not performed, the position information may not be stored and the algorithm for storing position information may be terminated.

Unlike this, when the wireless communications terminal 100 may be connected to the plurality of access points, the wireless communications terminal 100 may perform a data service and may calculate the position information regarding the current position thereof, using the received signal strength indication (RSSI) from the base station or using the global positioning system (GPS) embedded in the wireless communications terminal 100. Thereafter, the wireless communications terminal 100 may determine validity of the calculated position information. If the calculated position information is valid, the wireless communications terminal 100 may calculate the calculated position information regarding the wireless communications terminal 100 as the terminal coordinates and may store the calculated terminal coordinates in the memory unit 140.

Next, the control unit 110 may calculate a distance between the coordinates of the current position of the wireless communications terminal 100 included in the position information and the terminal coordinates with respect to each of the first AP 210, the second AP 220, and the third AP 230, which are stored in the memory unit 140, such that it may be determined whether the position information regarding the current position of the wireless communications terminal 100 is within the effective range of the Wi-Fi connection information.

Referring to FIG. 2, it may be appreciated that the first AP 210 and the second AP 220 are positioned within an effective range 201 of the Wi-Fi connection information indicated by a dotted line and the third AP 230 is outside of the effective range of the Wi-Fi connection information. Therefore, since the wireless communications terminal 100 is currently in the effective range, the Wi-Fi module 130 may be maintained in the ON state to be thereby connected to the first AP 210 or the second AP 220. In this case, whether to connect the wireless communications terminal 100 to the first AP 210 or the second AP 220 may be varied depending on current position environments of the wireless communications terminal 100 and may be output onto the display unit 150 by the control unit 110. In addition, whether to connect the wireless communications terminal 100 to the first AP 210 or the second AP 220 may be selected by a user.

Unlike FIG. 2, when the position information of the wireless communications terminal 100 is outside of the effective range of the Wi-Fi connection information, it denotes that the Wi-Fi function of the Wi-Fi module 130 is unnecessarily activated. Therefore, the control unit 110 may turn off the Wi-Fi module 130.

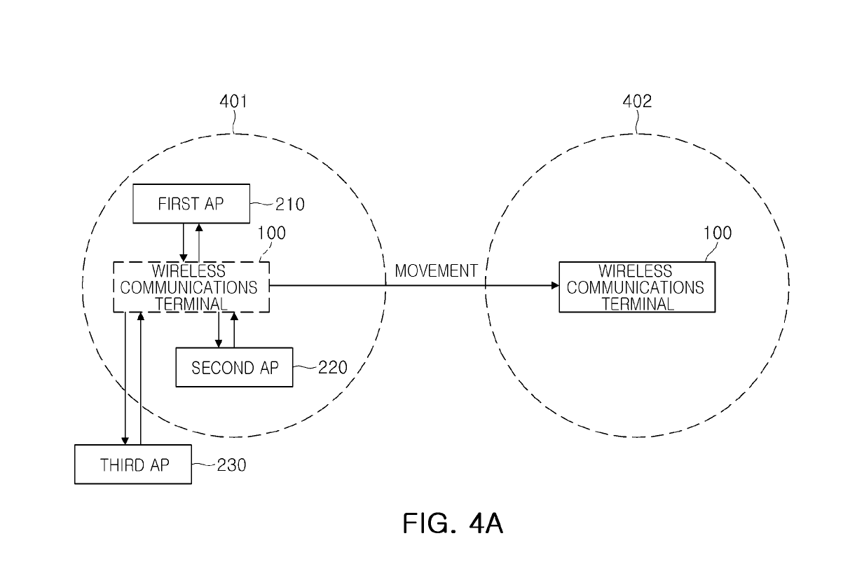

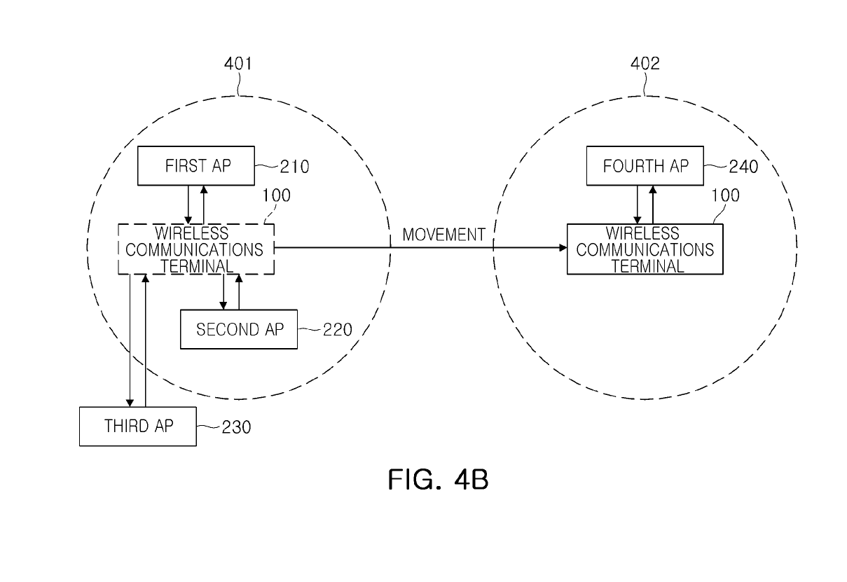

FIG. 4A is an exemplary configuration diagram illustrating a case in which the wireless communications terminal according to the embodiment of the present invention is moved.

FIG. 4B is another exemplary configuration diagram illustrating a case in which the wireless communications terminal according to the embodiment of the present invention is moved.

Referring to FIGS. 4A and 4B, FIGS. 4A and 4B showcases in which the wireless communications terminal 100 is moved. That is, the wireless communications terminal 100 is moved in a direction away from the access points to which it is connected.

The wireless communications terminal 100 after the movement thereof may recalculate position information regarding the current position thereof and may determine whether the recalculated position information is within an effective range 402 of Wi-Fi connection information previously stored in the memory unit 140.

FIG. 4A shows a case in which the recalculated position information is outside of the effective range 402 of the Wi-Fi connection information, that is, there is no connectable access point, and FIG. 4B shows a case in which the recalculated position information is within the effective range 402 of the Wi-Fi connection information, that is, a fourth AP 240, a connectable access point, may be present.

Therefore, in the case of FIG. 4A, the control unit 110 may turn off the Wi-Fi module 130, thereby preventing unnecessary power consumption. Meanwhile, in the case of FIG. 4B, the control unit 110 may output information indicating that the wireless communications terminal 100 may be connected to the fourth AP 240 on the display unit 150, such that the user may select whether to connect the wireless communications terminal 100 to the fourth AP 240.

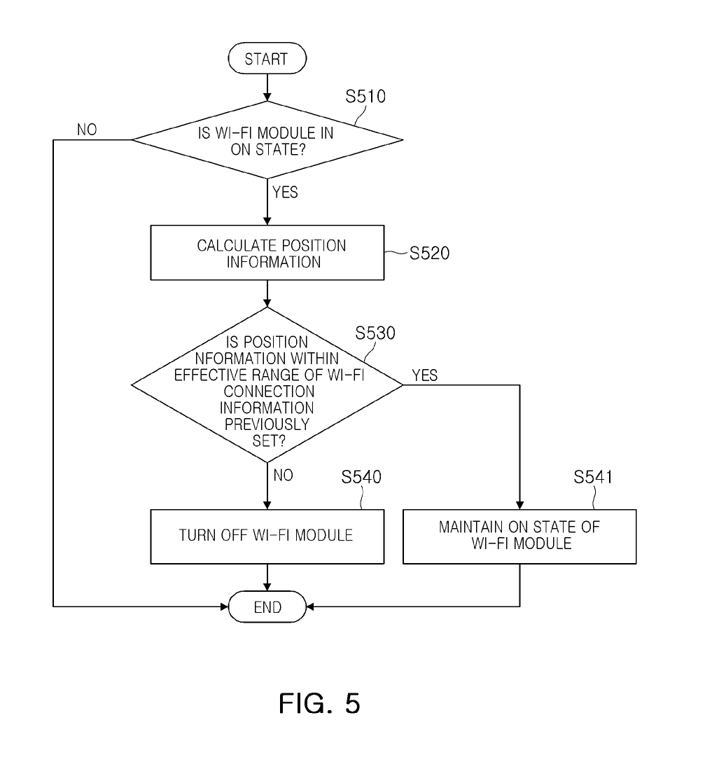

FIG. 5 is a flowchart illustrating an example of the control method of the wireless communications terminal 100 according to the embodiment of the present invention.

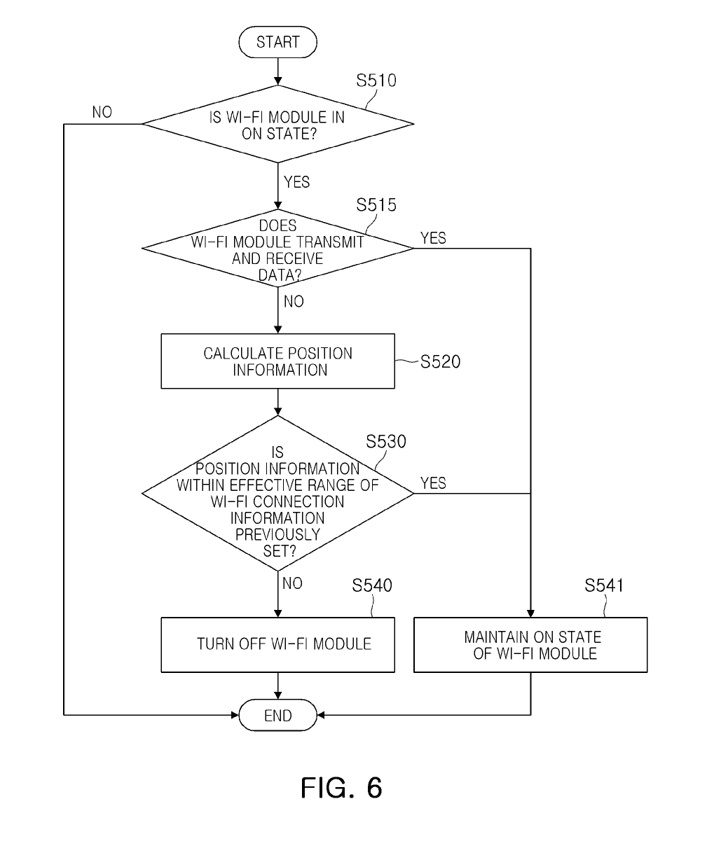

FIG. 6 is a flowchart illustrating another example of the control method of the wireless communications terminal 100 according to the embodiment of the present invention.

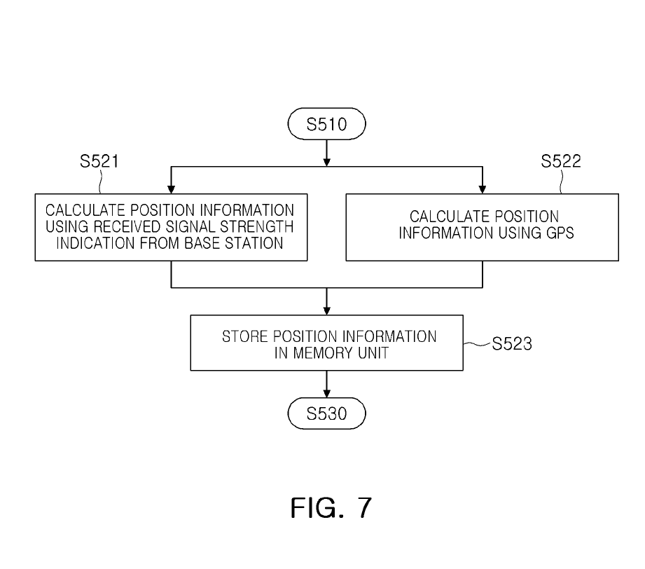

FIG. 7 is a flow chart illustrating a method of calculating position information according to the embodiment of the present invention.

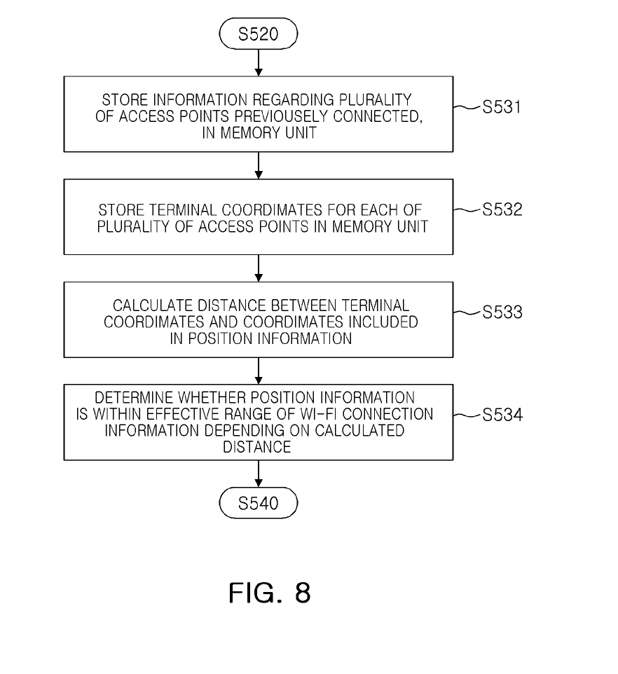

FIG. 8 is a flow chart illustrating a method of determining whether the position information is within an effective range of Wi-Fi connection information according to the embodiment of the present invention.

Referring to FIGS. 5 and 6, the control method of the wireless communications terminal according to the embodiment of the present invention may include determining whether the Wi-Fi module 130 is in the ON state (S510), determining whether the Wi-Fi module 130 transmits and receives data to and from the access point 200 (S515) when the Wi-Fi module 130 is in the ON state, calculating the position information when the Wi-Fi module 130 is in the ON state (S520), determining whether the position information is within an effective range of Wi-Fi connection information previously set (S530), and turning off the Wi-Fi module 130 when the position information is outside of the effective range of the Wi-Fi connection information (S540).

In the case in which the Wi-Fi module 130 is in the OFF state, the Wi-Fi module 130 may not need to be controlled. In addition, in the case in which the Wi-Fi module 130 transmits and receives data to and from the access point 200, the Wi-Fi module 130 may not need to be controlled, such that the ON state of the Wi-Fi module 130 may be maintained (S541).

Meanwhile, in the case in which the position information is within the effective range of the Wi-Fi connection information previously set, the control unit 110 may output information regarding access points to which the wireless communications terminal may be connected, on the display unit 150 to thereby allow the user to select the access point, such that the wireless communications terminal may be connected to the selected access point.

Meanwhile, when the Wi-Fi module 130 is in the ON state, the control method may further include periodically determining whether the Wi-Fi module 130 and the access point 200 transmit and receive data to and from each other.

Referring to FIG. 7, the calculating of the position information 5520 may include calculating the position information using the received signal strength indication (RSSI) from the base station (S521) or calculating the position information using the global positioning system (GPS) (S522). Next, the calculated position information may be stored in the memory unit 140 (S523).

Referring to FIG. 8, the determining of whether the position information is within the effective range of Wi-Fi connection information (S530) may include storing information regarding a plurality access points to which the wireless communications terminal 100 has previously been connected in the memory unit (S531), storing the terminal coordinates for each of the plurality of access points in the memory unit 140 (S532), calculating a distance between the respective terminal coordinates and the coordinates of the current position of the wireless communications terminal 100 included in the position information (S533), and determining whether the position information is within the effective range of the Wi-Fi connection information depending on the calculated distance (S534).

Referring to FIG. 5, in the case in which the position information is outside of the effective range, the control unit 110 may turn off the Wi-Fi module 130, thereby preventing unnecessary power from being wasted. In the case in which the position information is within the effective range, the ON state of the Wi-Fi module 130 may be maintained and the control unit 110 may output the information regarding the access points in the effective range, onto the display unit 150, to thereby allow the user to select the access point.

Therefore, when the calculated position information is outside of the effective range of the Wi-Fi connection information previously set, the Wi-Fi module 130 may be turned off, such that the unnecessary search for the access point 200 by the wireless communications terminal 100 may be prevented. In addition, the amount of battery power consumed in the wireless communications terminal 100 may be decreased.

As set forth above, in the wireless communications terminal and the control method thereof according to the embodiments of the present invention, when the calculated position information is outside of the effective range of the Wi-Fi connection information previously set, the Wi-Fi module may be turned off, such that the unnecessary search for the access point by the wireless communications terminal may be prevented. In addition, the amount of battery power consumed in the wireless communications terminal may be decreased.

While the present invention has been shown and described in connection with the embodiments, it will be apparent to those skilled in the art that modifications and variations can be made without departing from the spirit and scope of the invention as defined by the appended claims.

What is claimed is:

1. A wireless communications terminal, comprising:
a Wi-Fi module connected to the Internet wirelessly via an access point (AP);
a mobile communications module calculating position information regarding the wireless communications terminal;
a memory unit storing Wi-Fi connection information previously set; and
a control unit turning off the Wi-Fi module in a case in which the position information is outside of an effective range of the Wi-Fi connection information when the Wi-Fi module is in an ON state.

2. The wireless communications terminal of claim 1, wherein the position information is calculated using a received signal strength indication (RSSI) from a base station or using a global position system (GPS).

3. The wireless communications terminal of claim 1, wherein the Wi-Fi connection information includes:
information regarding a plurality of access points to which the wireless communications terminal has been previously connected; and
terminal coordinates for each of the plurality of access points to which the wireless communications terminal has been previously connected.

4. The wireless communications terminal of claim 3, wherein the control unit calculates a distance between the respective terminal coordinates and coordinates of a current position of the wireless communications terminal included in the position information, and determines whether the plurality of access points are within the effective range.

5. The wireless communications terminal of claim 4, wherein the control unit connects the wireless communications terminal to one of the plurality of access points determined as being within the effective range.

6. The wireless communications terminal of claim 1, further comprising a display unit outputting the ON or an OFF state of the Wi-Fi module.

7. The wireless communications terminal of claim 1, wherein the control unit maintains the ON state of the Wi-Fi module when the Wi-Fi module transmits and receives data to and from the access point, while being in the ON state.

8. The wireless communications terminal of claim 1, wherein the control unit periodically determines whether the Wi-Fi module and the access point transmit and receive data to and from each other.

9. A control method of a wireless communications terminal, the control method comprising:
determining whether a Wi-Fi module is in an ON state;
calculating position information regarding the wireless communications terminal and determining whether the position information is within an effective range of Wi-Fi connection information previously set, when the Wi-Fi module is in the ON state; and
turning off the Wi-Fi module when the position information is outside of the effective range of the Wi-Fi connection information.

10. The control method of claim 9, further comprising: determining whether the Wi-Fi module transmits and receives data to and from the access point.

11. The control method of claim 10, further comprising: maintaining the ON state of the Wi-Fi module when the Wi-Fi module transmits and receives data to and from the access point.

12. The control method of claim 9, further comprising: periodically determining whether the Wi-Fi module and the access point transmit and receive data to and from each other when the Wi-Fi module is in the ON state.

13. The control method of claim 9, wherein the determining of whether the position information is within the effective range of the Wi-Fi connection information includes: calculating the position information using a received signal strength indication (RSSI) from a base station or calculating the position information using a global positioning system (GPS).

14. The control method of claim 9, wherein the determining of whether the position information is within the effective range of the Wi-Fi connection information includes:
storing information regarding a plurality of access points to which the wireless communications terminal has been previously connected in a memory unit;
storing terminal coordinates for each of the plurality of access points in the memory unit;
calculating a distance between the respective terminal coordinates and coordinates of a current position of the wireless communications terminal included in the position information; and
determining whether the position information is within the effective range of the Wi-Fi connection information, depending on the calculated distance.

15. The control method of claim 14, further comprising: connecting the wireless communications terminal to one of plurality of access points determined as being within the effective range.
